(19) United States
(12) Patent Application Publication
(10) Pub. No.: US 2014/0106061 A1
(43) Pub. Date: Apr. 17, 2014

(54) SYSTEM AND METHOD FOR TAMPER EVIDENT FLUORESCENT COATING

(71) Applicant: Ray E. Hilburn, Wimberley, TX (US)

(72) Inventor: Ray E. Hilburn, Wimberley, TX (US)

(21) Appl. No.: 14/052,242

(22) Filed: Oct. 11, 2013

Related U.S. Application Data
(60) Provisional application No. 61/713,581, filed on Oct. 14, 2012.

(51) Int. Cl. C09D 5/33; B65D 83/14

(52) U.S. Cl. CPC C09D 5/004; B65D 83/752
USPC 427/7; 239/337; 106/287.19

(57) ABSTRACT

In some embodiments, a method and/or system may include assessing a disturbance of a marked enclosure. The method may include applying a composition to at least a portion of an enclosure. The method may include forming a coating over at least the portion of the enclosure using the applied composition. The coating may be substantially translucent and fluorescent. The method may include acquiring evidence using the coating upon disturbance of the enclosure. The method may include detecting evidence of disturbance acquired by the coating using an ultraviolet light source. In some embodiments, the enclosure substantially contains an explosive device. In some embodiments, the coating may be substantially undetectable within the standard visible light spectrum.

### PRIORITY CLAIM

This application claims priority to U.S. Provisional Patent Application No. 61/713,581 to Hilburn entitled “UNDETECTABLE IR INTRUSION DETECTION SYSTEM C-IED RELATED” filed on Oct. 14, 2012, which is incorporated by reference herein.

### BACKGROUND

1. Technical Field

This disclosure relates generally to tamper detection systems and methods, and more particularly to assessing tampering of enclosures to assess the occurrence of the placement of explosive devices.

2. Description of the Related Art

As part of a broader mission of stabilizing the Middle East the United States of America installed or repaired thousands of miles of roadways in the Middle East, especially in Afghanistan. Successful roads, it is hypothesized, may result in a stronger society, giving communities increased access to health, education, markets and government services. However, military and government forces have to constantly be alert to the improvised explosive devices (IED) threat presented by the buried victim operated improvised explosive devices (VOIED), command wire IED (CWIED), and radio controlled IED (RCIED). The common factor of all of these weapons is their emplacement. Every one of these weapons relies on concealment and the most efficient and effective method is in the culverts that run underneath the rural and urban roadways in Afghanistan.

As pointed out, the United States military contracted out a mission of culvert denial systems to be emplaced throughout Afghanistan. Through corruption, fraud and poor oversight, this mission was a failure. Secondarily, where these systems were placed, the local insurgents removed the systems, inserted homemade explosives (HME) in greater weights, replaced the grating and waited for a convoy to pass. Even as military forces went to a dismounted patrol protocol as used by the British forces in Northern Ireland, a soldier has no safe stand-off in which to determine if the culvert denial system has been compromised.

Culverts are a commonly used place to hide IED. IEDs are the primary killer of American soldiers in foreign operations. For example, last year, the Taliban managed to deploy 16,000 IEDS. Currently culvert denial systems are used to inhibit IEDs from being positioned in a culvert. Culvert denial systems today often look like screens placed across a drain so that water and debris can flow through, without leaving enough room for bombs to be positioned. The U.S. inspector general in Afghanistan has warned the military that current protections against IEDs on a major highway in Afghanistan were inadequate and posed a threat to troops. A problem with the screens currently being used is that insurgents just remove the screen, position an IED, and then replace the screen such that it is difficult for American soldiers to assess that the screen has been disturbed.

Current military tactics for clearing chosen routes include: dismounted patrols, using detection equipment to identify devices along roadways and during route clearance operation; physically trying to view inside culverts to determine if a culvert denial system has been compromised; and if the culvert denial system has been compromised, determining who did the terrorist action and bringing them to justice under the Afghan Rule of Law. Currently, there is not a manufactured system and/or method which allows soldiers to assess whether or not a screen has been disturbed.

### SUMMARY

In some embodiments, a method and/or system may include assessing a disturbance of a marked enclosure. The method may include applying a composition to at least a portion of an enclosure. The method may include forming a coating over at least the portion of the enclosure using the applied composition. The coating may be substantially translucent and fluorescent. The method may include acquiring evidence using the coating upon disturbance of the enclosure. The method may include detecting evidence of disturbance acquired by the coating using an ultraviolet light source. In some embodiments, the enclosure substantially contains an explosive device. In some embodiments, the coating may be substantially undetectable within the standard visible light spectrum.

### BRIEF DESCRIPTION OF THE DRAWINGS

The following detailed description makes reference to the accompanying drawings, which are now briefly described.

FIG. 1 depicts an embodiment of flow chart representing a method for assessing disturbance of a marked enclosure.

FIG. 2 depicts an embodiment of a culvert denial system coupled to a culvert.

FIG. 3 depicts an embodiment of a culvert denial system coupled to a culvert.

FIG. 4 depicts an embodiment of a portion of an intruder who has been marked by a coating when shown under an ultraviolet light.

FIG. 5 depicts an embodiment of a portion of an intruder's clothing who has been marked by a coating when shown under an ultraviolet light.

FIG. 6 depicts an embodiment of a portion of a trail of evidence left behind by an intruder who has been marked by a coating when shown under an ultraviolet light.

Specific embodiments are shown by way of example in the drawings and will be described herein in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

The headings used herein are for organizational purposes only and are not meant to be used to limit the scope of the description. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicated open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third die electrically connected to the module substrate” does not preclude scenarios in which a “fourth die electrically connected to the module substrate” is connected prior to the third die, unless otherwise specified. Similarly, a “second” feature does not require that a “first” feature be implemented prior to the “second” feature, unless otherwise specified.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. §112, paragraph six, interpretation for that component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF EMBODIMENTS

### Definitions

Unless defined otherwise, all technical and scientific terms used herein have the same meaning as commonly understood by one of ordinary skill in the art.

The term “connected” as used herein generally refers to pieces which may be joined or linked together.

The term “coupled” as used herein generally refers to pieces which may be used operatively with each other, or joined or linked together, with or without one or more intervening members.

The term “directly” as used herein generally refers to one structure in physical contact with another structure, or, when used in reference to a procedure, means that one process effects another process or structure without the involvement of an intermediate step or component.

The term “primer,” as used herein, generally refers to an undercoat of paint or size applied to prepare a surface (e.g., for painting).

The term “sealant,” as used herein, generally refers to any of various liquids, paints, chemicals, or soft substances that may be applied to a surface or circulated through a system of pipes or the like, drying to form a hard, substantially watertight coating.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

In some embodiments, a composition coating may function to safeguard the wellbeing of dismounted patrols, route clearance vehicles and maneuver units from the catastrophic effects of the successful detonation of Improvised Explosive Devices.

The coating composition may accomplish this goal, by providing a visual signal, using Ultra Violet (UV) light sources to alert coalition forces that an area has been compromised. Not only will this visual alert be critical to commanders to take evasive actions at a particular location but may enable the identification of the individual(s) responsible for the intrusion.

In some embodiments, one or more users may spray or brush the coating composition onto the surface of the culvert and culvert denial system covering the culvert/culver denial system and surrounding surfaces with a substantially invisible coating that may protect the area from undetected intrusion.

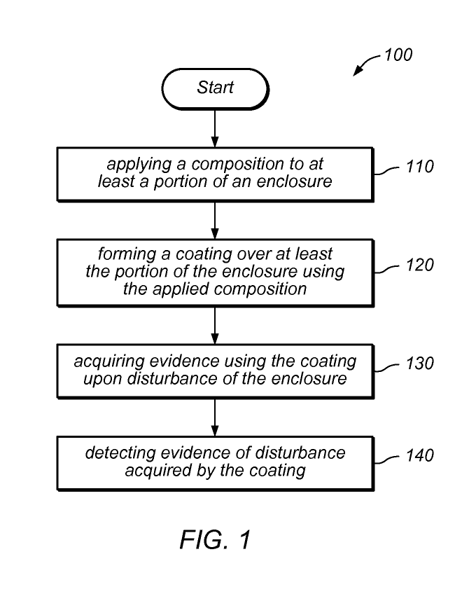

FIG. 1 depicts an embodiment of flow chart representing a method 100 for assessing a disturbance of a marked enclosure. In some embodiments, a method and/or system may include assessing a disturbance of a marked enclosure. The method may include applying 110 a composition to at least a portion of an enclosure. The method may include forming 120 a coating over at least the portion of the enclosure using the applied composition. The coating may be substantially translucent and fluorescent. The method may include acquiring 130 evidence using the coating upon disturbance of the enclosure. The method may include detecting 140 evidence of disturbance acquired by the coating using an ultraviolet light source. In some embodiments, the enclosure substantially contains an explosive device. In some embodiments, the coating may be substantially undetectable within the standard visible light spectrum.

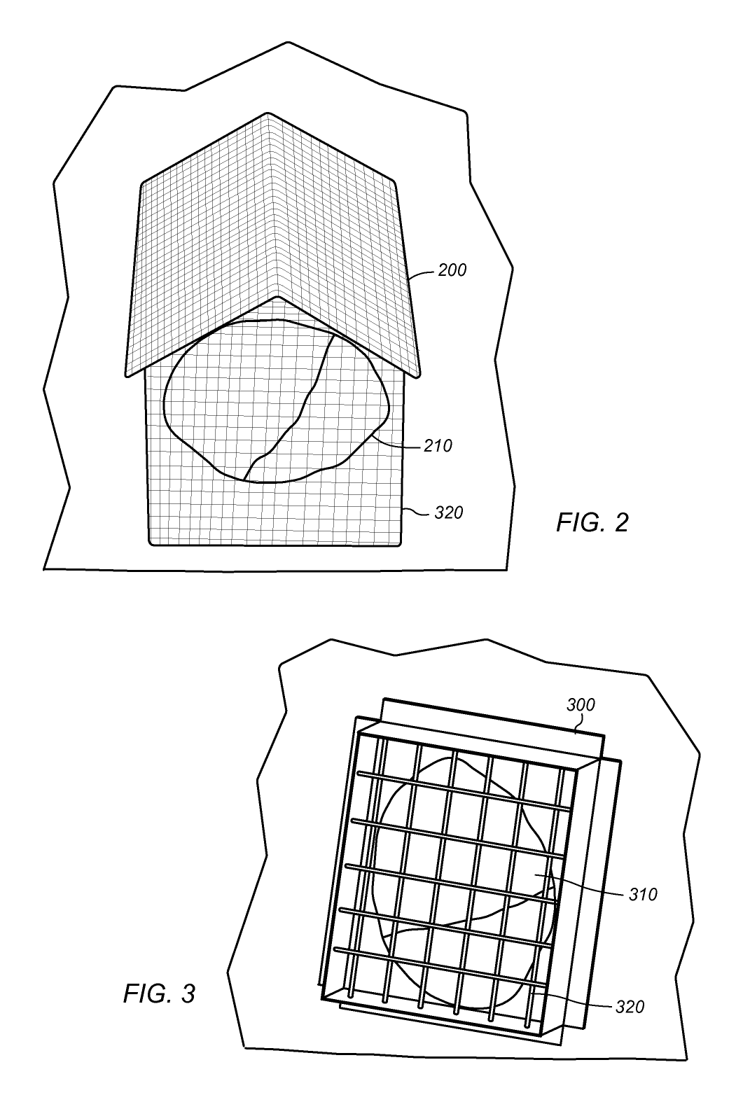

FIG. 2 depicts an embodiment of a culvert denial system 200 coupled to a culvert 210 positioned adjacent a roadway. FIG. 3 depicts an embodiment of a security grate covering or a culvert denial system 300 coupled to a culvert 310. In the example depicted in FIG. 2 the enclosure comprises a culvert as described. Coupled to an opening of the culver is culvert denial system 200. At least a portion of the culvert denial system may be treated with composition to form a coating 320. The coating then allows troops to assess whether or not anyone has tampered with the culvert denial system. The composition may be applied to one or more portions of the surrounding enclosure as well. For example, in some embodiments, the composition may be applied to an area surrounding the culvert such that it may be ascertained if an intruder approached the enclosure without anyone have to get within close proximity to the enclosure.

In some embodiments, the coating is not visible to the naked eye (e.g., the coating is substantially undetectable within the standard visible light spectrum). However, the coating may mark an intruder, allowing for biometric comparisons, and may be transferred to clothing and shoes for later identification. The coating may not be removed easily (e.g., the coating may not be washed off with soap and water) once transferred to an intruder. In some embodiments, the coating may remain effective for an extended period of time (e.g., >3 months with a single application). Upon contact with the coating, the intruder may be identifiable using simple, commercial light sources. In some embodiments, the coating may be tacky, or at least remain tacky for an extended period of time (e.g., >3 months) such that the coating composition is more easily transferred to an intruder upon contact. A coating being tacky may include the coating remaining at least partially fluid for an extended period of time.

The composition may be applied by spray to concrete, asphalt, hard ground or to any entrance point where intrusion is an issue. The coating may be non-visible to the human eye and as such no evidence of marking/contamination to intruders is evident without special means.

In some embodiments, the composition may leave biometric evidence of the individual on the surface to which the composition has been applied. Biometric evidence may include, for example, fingerprint impressions left in the coating. As such, biometric evidence may be collected and stored in order to be used to identify and apprehend the intruder at a later date.

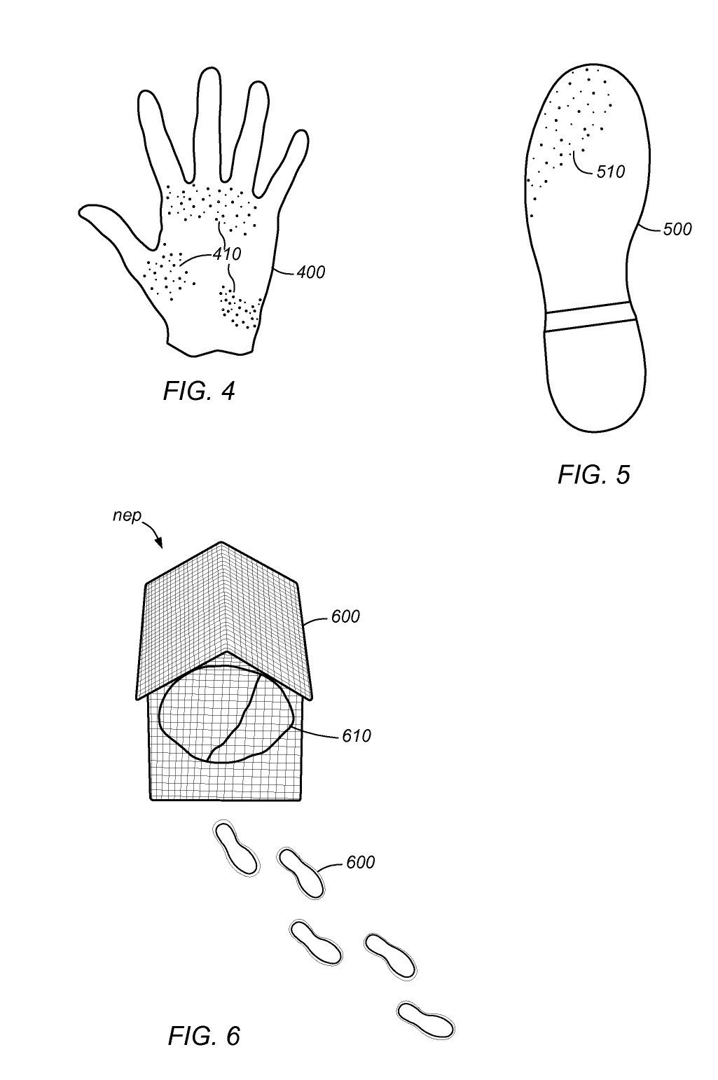

In some embodiments, the composition may leave evidence on clothing and/or foot wear for tracking and identification purposes. Composition transfer may occur when the treated surface is touched. FIG. 4 depicts an embodiment of a portion 400 of an intruder who has been marked 410 by a coating when shown under an ultraviolet light. Composition transfer may occur if the individual brushes against a marked area or his affected body parts on his clothes and may be transferred to shoes or other surfaces. FIG. 5 depicts an embodiment of a portion 500 of an intruder's clothing who has been marked 510 by a coating when shown under an ultraviolet light.

This transfer may be visible, using UV light, as a “blank” in the treated surface areas (i.e., an area of the treated surface which has less or no coating compared to the surrounding areas) and would be a “positive” indication that an enclosure system has been tampered with. The distance of detection may be dependent upon the strength of the UV light source. In some embodiments, hand held units may be mounted on extenders to provide safe stand-off and at night the light will be even more pronounced for added security and safety.

FIG. 6 depicts an embodiment of a portion 600 of a trail of evidence left behind by an intruder who has been marked by a coating (e.g., applied to a culvert denial system 600 coupled to a culvert 610) when shown under an ultraviolet light as is depicted in FIG. 6. In such a case an intruder has come into contact with a marked portion of an enclosure and then transferred the coating composition from himself to the surrounding landscape and/or structures. The

[symbol]

In some embodiments, the composition may be formed as part of a coating. In some embodiments, the composition may be applied to a surface as part of a modified paint. There are many types of paints. Paint is a combination of a variety of substances and chemical such as pigments, solvents, additives, and binding elements, depending upon the surface to which the paint will be applied. Examples of chemicals found in paint may include, for example, water, resin, calcium carbonate, mica, polyurethanes, Titanium oxide, etc. Paint may include any liquid, liquefiable, or mastic composition which, after application to a surface in a thin layer, is converted to a solid or substantially solid film. It is most commonly used to protect, color, or provide texture to objects.

Typically paint is a coating material made by combining a solid phase of powdered ingredients with a binder and dispersing it into a liquid generally referred to as the “vehicle.” Colorants may be added by blending to produce a final product, which is applied to interior or exterior surfaces. Upon drying there is left a decorative and/or protective film. Most paints are brushed, rolled or sprayed onto surfaces. As a result, paint may contain a wide variety of chemicals.

Specialty matrices may be used depending on what surface a coating is applied to. For example, in some embodiments, a coating composition may be used as a paint or paint equivalent. A paint equivalent may include a wet adhesion monomer containing a cross-linkable hydroxyl group useful in the making of latex paints. Methods for making such aqueous polyurethane-vinyl polymer dispersion may be found in U.S. Pat. No. 6,538,143 to Pinschmidt, Jr. et al. Paints are typically liquids which are useful for application to a substrate, such as wood, metal, glass, ceramics, fiberglass, composite materials, cardboard, corrugated board, paper, textiles, non-woven materials, plastic, foam, tape or a combination thereof, in a thin layer. Paints are typically used to protect the surface of the substrate from elemental damage and/or physical damage. Paints are also commonly used for decoration and aesthetic purposes. Paints find very broad commercial use and also find a variety of uses in the home. Paints, their formulations, ingredients, additives and processing conditions are generally described in Kirk-Othmer-Paint; pg. 1049-1069, Vol. 17; 1996, by Arthur A. Leman, the disclosure of which is incorporated herein.

Coating compositions may be prepared by paint making techniques which are known in the coatings art. In some embodiments, at least one pigment is well dispersed in a waterborne medium under high shear such as is afforded by a mixer. An emulsion-polymerized addition polymer may be added under low shear stirring along with other coatings adjuvants as desired. The coating composition may contain, in addition to the pigment(s) and the latex polymer, conventional coatings adjuvants such as, for example, colloids, emulsifiers, coalescing agents or solvents (e.g., DMF and ethylene glycol), curing agents, thickeners, humectants, wetting agents, biocides, plasticizers, antifoaming agents, colorants, waxes, pH adjusters (e.g., boric acid), and antioxidants.

In particular, coalescing agents or solvents are used in architectural and industrial latex coatings to promote film formation, and selection of the proper coalescing solvent is a key to the formulation of superior latex coatings. A coalescent may be used in water based systems as a fugitive plasticizer to soften the resin particles, enabling them to fuse into a continuous film. During the drying process, most or all of the coalescent may evaporate, allowing the film to achieve the desired hardness. Other coalescing agents or solvents may include, but are not limited to, dimethylsulfoxide, dimethylformamide, acetone, butanol, propanol, isopropanol, pentanol, hexanol, propylene glycol, ethylene glycol, ethylene glycol 2-ethylhexyl ether, di(ethylene glycol)2-ethylhexyl ether, ethylene glycol butyl ether, di(ethylene glycol) hexyl ether, 3-ethylhexanol, hexanol, 1,4-butanediol and the like.

The coating composition may be applied to a surface such as, for example, metal, wood, sheet rock, ceramic, cultured marble and plastic, using conventional coating application methods such as, for example, brush, roller, drawdown, dipping, curtain coater, and spraying methods such as, for example, air-assisted spray, airless spray, high volume low pressure spray, and air-assisted electrostatic spray.

In some embodiments, the coating composition may be applied to a surface using an aerosol spray. Aerosol spray is a type of dispensing system which may create an aerosol mist of liquid particles. This may be used with a container that contains a liquid under pressure. When the container's valve is opened, the liquid may be forced out of a small opening and emerge as an aerosol or mist. As gas expands to drive out the payload, only some propellant evaporates inside the container to maintain an even pressure. Outside the container, the droplets of propellant evaporate rapidly, leaving the payload suspended as very fine particles or droplets. Typical liquids dispensed in this way are insecticides, deodorants and paints. An atomizer is a similar device that is pressurized by a hand-operated pump rather than by stored gas.

Coatings may include paint compositions, caulk compositions, adhesive compositions and sealant compositions, and methods of preparing such compositions.

Coatings may include a latex paint composition comprising a pigment, and, optionally, a thickener.

In some embodiments, compositions may take the form of a coating, adhesive, sealant or elastomer.

Typically, paints are described as latex, alkyd, or oil-based paints. Additionally, a wide variety of paints are water-based. These designations identify the binder used in the manufacture of the paint and the solvent, if any, which is used. Typically classes of latex paints include gloss, semi-gloss, flat, and satin. These terms describe the shininess of the paint surface after the paint has dried on the substrate. Paints typically contain binders/resins, such as latex emulsions. A common latex emulsion employed in paints is based on acrylic and vinyl acetate. Paints often include pigments (organic and inorganic), inorganic extenders, filler pigments, solvents, and additives, such as thickeners, protective colloids, biocides, driers, pigment dispersants, pigment extenders, adhesion promoters, surfactants, and defoamers. When paints are manufactured, surface active agents are used to stabilize the emulsion polymerization and also regulate the resulting polymer particle size.

In some embodiments, a formulation may contain matte finish additives (low to no gloss or flat) and thixotropic additives (anti-sag components). Formulations including metal oxides (e.g. silica) and surface modified metal oxides (e.g. silica with trimethyl silyl, vinyl dimethyl silyl, etc.) may be found in U.S. Pat. No. 6,720,368 to Field, which is incorporated by reference as if fully set forth herein.

The aforementioned monomers may be utilized to prepare latexes useful in coatings and paints. Typically the monomers are selected to give an acrylic latex emulsion, for durable exterior paint. These monomers may include methyl methacrylate, butyl acrylate, and 2-ethylhexyl acrylate, and mixtures thereof. Non-acrylic based monomers are typically used for interior paints, except in the cases of gloss and semi-gloss paints. Among other monomers, vinyl acetate, butyl acrylate and mixtures thereof, are commonly used in a variety of paint formulations.

Alkyd resins are produced by reaction of a polybasic acid, such as phthalic or maleic anhydride, with a polyhydric alcohol, such as glycerol, pentaerythitol, or glycol, in the presence of an oil or fatty acid. (See Kirk-Othmer-Paint; pg. 1049-1069; Vol. 17; 1996; Arthur A. Leman). Alkyd resins are typically described as long oil, medium oil, and short oil alkyds. Such description is based on the amount of oils and/or fatty acids in the resins. Long-oil alkyds generally have an oil content of 60% or more; short oil alkyds, less than 45%; and medium oil alkyds have an oil content in between the two. The short and medium oil alkyds are based on semidrying and nondrying oils, whereas long-oil alkyds are based on semidrying and drying oils.

Typical pigment extenders used in paints include, for example, titanium dioxide, calcium carbonate, talc, clay, silica, zinc oxide, feldspar, corrosion resistance extenders, mildew resistance extenders, and film-hardening extenders, and mixtures thereof. Solvents typically used in paints include, for example, mineral spirits, glycol ethers (e.g. ethylene glycol and propylene glycol) and the like. In addition to binders, solvents, pigments, and extenders, many paints contain additives. Additives include, for example, thickeners, pigment dispersants, surfactants, defoamers, biocides, mildewcides, preservatives, driers, defoamers, antiskinning agents and pH adjusting agents and mixtures thereof (e.g. acids and bases). Additional additives include hydroxyethylcellulose, hydrophobically modified alkali-soluble emulsions, and hydrophobically modified ethylene oxide urethanes.

In some embodiments, the composition may include one or more of the following components: a solid phase, a binder, a liquid phase, a colorant, or a tackifier.

In some embodiments, a solid phase may include titanium dioxide. Solids such as aluminum oxide, silica and calcium carbonate may serve as extenders reducing costs. Solids such as bentonite or kaolinite may add body and modify flow properties. Diatomaceous earth may reduce gloss. Zinc oxide may increase whiteness.

In some embodiments, a binder may induce film forming in the composition upon application to a surface. The binder may depend upon if the composition is a non-aqueous or latex based paint. Non-aqueous paint binders may be oil-based or alkyd. Latex paints contain polymeric substances, such as polyvinyl acetate.

In some embodiments, a liquid phase may facilitate all the components of the paint to work together and to be applied properly across the surface. Much of the liquid phase of latex paints is water, while non-aqueous paints contain thinner, such as mineral spirits. Additional water or paint thinner may be added if a thinner coating is desired, covering more surface area per volume of paint. Thinning a paint usually reduces the paints resistance to wear.

In some embodiments, a tackifier is a chemical compounds used in formulating adhesives to increase the tack, the stickiness of the surface of the adhesive. They are usually low-molecular weight compounds with high glass transition temperature. At low strain rate, they provide higher stress compliance, and become stiffer at higher strain rates. Tackifiers tend to have low molecular weight, and glass transition and softening temperature above room temperature, providing them with suitable viscoelastic properties. Tackifiers may include resins (e.g., rosins and their derivates, terpenes and modified terpenes, aliphatic, cycloaliphatic and aromatic resins (C5 aliphatic resins, C9 aromatic resins, and C5/C9 aliphatic/aromatic resins), hydrogenated hydrocarbon resins, and their mixtures, terpene-phenol resins (TPR, used often with ethylene-vinyl acetate adhesives)).

### EXAMPLES

### Materials & Methods

The paint was provided in two forms; in liquid form for brush on application, and in compressed form for aerosol application. Liquid samples were drop deposited on glass microscope slides for testing. The thickness of sticky paint for fluorescent analysis was thicker than the applications on surfaces for long term testing. Fluorescent coating thickness was sufficient that when the coated glass slide was placed upon a printed text, the text was obscured and not visible. The samples were measured using a Horiba Fluoromax-3 spectrofluorometer. Excitation was conducted from 300-600 nm and emissions were recorded for wavelengths between 320-620 nm both in 5 nm incremental steps. Paint was aerosol applied to surfaces and allowed to remain in open air for three weeks to assess the tackiness and spectral response of the paint. Surfaces coated included smooth glass, textured glass, stainless steel, acrylic, polystyrene, clay soil, and cotton cloth. Analysis of the paint's ability to remain adhered and transferred was carried out using a 365 nm light source.

### Results & Discussion

Spectral analysis of the paint was plotted on a three dimensional plot. The trough or trench is the result of the excitation and emission values being equal. The system reads the excitation source as the signal. These values were manually set to zero for plotting and data analysis. The composition has a major peak (.ex=365 nm, .em=535) and a secondary peak (.ex=385 nm, .em=435 nm). The emission wavelength has an edge which decreases approximately 6 nm for every increase of 1 nm in the excitation wavelength. No appreciable signal was seen for excitation wavelengths shorter than 300 nm, noting that at 254 nm no emission signal was seen but was tested. A 254 nm light source is the other common ultraviolet light source, usually coupled with 365 nm, which is why the 254 nm wavelength was investigated. The surfaces with aerosol application remained fluorescent after being allowed to rest for three weeks. Transfers of the sticky paint was observed from the smooth glass, textured glass, stainless steel, acrylic, polystyrene and cloth surfaces to a latex laboratory glove. The cloth surface transfer was only partial, as the paint was observed remaining mainly on the original cotton surface. The paint applied to the clay soil was not transferable to a latex glove when contact was made with the sample. Sufficient force was required to transfer the paint and soil to the glove to observe contact via fluorescence. The cotton textile appears to have absorbed the paint, limiting the amount available for transfer. The same situation appears to have occurred with the clay soil, but to greater degree as a result of the higher surface area of the particulate. No chemical analysis was performed on the material, but an odor of turpentine was observed. The material was tacky after three weeks when exposed to the air, resembling pine tar or tree resin. This observation is backed by the required use of ethanol and acetone for cleanup of surfaces when water would not solvate the material for cleanup and removal.

### Laboratory Testing Conclusions

The sticky paint is fluorescent material that is applied in a liquid form to surfaces suspended in a flammable solvent. It remains tacky and easily transferred from low textured surfaces such as metals, glass, and polymers for a minimum of three weeks after application in a laboratory setting. The transferability of the material is diminished on linens and severely diminished when applied to soil. In all cases, the fluorescent properties appear unchanged. The paint possesses two major excitation-emission peaks, the major peak is located at 365 nm excitation and 535 nm emission. The minor peak is located at 385 nm excitation and 435 nm emission. The material is capable of fluorescent detection using a long way ultraviolet source at 365 nm. Care should be exercised when handling the material, as it will stain quickly absorb into the skin and requires a non-polar or denatured alcohol solvent to be removed.

### Formulation

In some embodiments, a formulation may include: 6 Tsp: Chromium Iron Oxide; 4 Tsp: Manganese Antimony Titanium Buff Rutile; 1 Tsp: Chrome Antimony Titanium Buff Rutile; 3 Tsp: Cobalt Chromite Green Spinel; 1 Tsp: Cobalt Chromite Blue-Green Spinel; 16 oz: Water; and 8 oz: Waterborne paint (methanol, coalescent, thickener, ammonium hydroxide and water solution) i.e. Aexcel 72w-A042 C87, White, Jetdry.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method for assessing a disturbance of a marked enclosure, comprising:
applying a composition to at least a portion of an enclosure;
forming a coating over at least the portion of the enclosure using the applied composition, wherein the coating is substantially translucent and fluorescent;
acquiring evidence using the coating upon disturbance of the enclosure; and
detecting evidence of disturbance acquired by the coating using an ultraviolet light source.

2. The method of claim 1, wherein the enclosure substantially contains an explosive device.

3. The method of claim 1, wherein the coating is substantially undetectable within the standard visible light spectrum.

4. The method of claim 1, wherein the coating is tacky.

5. The method of claim 1, wherein the coating remains for an extended period of time at least partially fluid.

6. The method of claim 1, wherein said acquiring comprises an intruder disturbing the coating.

7. The method of claim 1, wherein said acquiring comprises an intruder forming at least one fingerprint in the coating.

8. The method of claim 1, wherein said acquiring comprises an intruder transferring at least some of the coating onto the intruder or articles associated with the intruder.

9. The method of claim 1, wherein said acquiring comprises an intruder transferring at least some of the coating onto the intruder or articles associated with the intruder and from there transferring at least some of the coating to items which come in contact with coated portions of the intruder or articles associated with the intruder.

10. The method of claim 1, wherein said applying comprises using an aerosol spray can.

11. The method of claim 1, wherein the enclosure comprises a culvert.

12. The method of claim 1, wherein the enclosure comprises a culvert positioned alongside a roadway.

13. The method of claim 1, wherein the portion of the enclosure comprises a security grate covering an opening of a culvert.

14. A system, comprising:
a container configured to deliver a composition using an aerosol propellant to form, during use a coating at least a portion of an enclosure, wherein the coating is substantially translucent and fluorescent;
wherein the coating is configured to denote evidence of disturbance of the enclosure when exposed to an ultraviolet light source.

15. The system of claim 1, wherein the portion of the enclosure comprises a security grate covering an opening of a culvert.

16. The system of claim 1, wherein the enclosure substantially contains an explosive device.

17. The system of claim 1, wherein the coating is substantially undetectable within the standard visible light spectrum.

18. The system of claim 1, wherein the coating is tacky.

19. The system of claim 1, wherein the coating remains for an extended period of time at least partially fluid.

20. A coating composition, comprising:
an ultraviolet reflective component;
a colorant;
a first solvent; and
a paint miscible in the first solvent, comprising:
a coalescent;
a thickener; and
a second solvent.
